(19) United States
(12) Patent Application Publication
(10) Pub. No.: US 2020/0296510 A1
(43) Pub. Date: Sep. 17, 2020

(54) INTELLIGENT INFORMATION CAPTURING IN SOUND DEVICES

(71) Applicant: Microsoft Technology Licensing, LLC, Redmond, WA (US)

(72) Inventors: Sharon Hang Li, Redmond, WA (US); Xiangcheng Kong, Redmond, WA (US); Chi Hang Nguy, Issaquah, WA (US); Alperen Kok, Bellevue, WA (US); John Hoegger, Woodinville, WA (US); Rui Hu, Redmond, WA (US); Tomasz Religa, Seattle, WA (US)

(21) Appl. No.: 16/353,976

(22) Filed: Mar. 14, 2019

(51) Int. Cl. H04R 3/04; G10L 21/0232; G10L 15/26; G06F 3/16; G06F 17/27

(52) U.S. Cl. CPC H04R 3/04; G10L 21/0232; G10L 15/26; G10L 2021/02163; G06F 17/277; G06F 17/2705; H04R 2460/01; G06F 3/167

(57) ABSTRACT

Sound devices such as hearing aids and headphones configured for intelligent information capturing are disclosed herein. In one embodiment, a sound device is a hearing aid or a noise-canceling headphone. The sound device includes a microphone, a speaker, a processor, and a memory containing a set of sound models each corresponding to a known sound. Upon receiving a digital sound signal representing an ambient sound captured via the microphone, the sound device can determine whether the digital sound signal includes a signal profile that matches the sound signature of one of the sound models stored in the memory. In response to determining that the digital sound signal has a signal profile that matches the sound signature of one of the sound models, the sound device can output, via the speaker, an audio message to the user identifying the known sound while suppressing the captured ambient sound from the environment.

### BACKGROUND

Noise reduction is a process of removing or reducing background noise from a sound signal such that a desired sound can be more noticeable. For example, a desired sound may be a conversation with another person or music played via a speaker or headphone. The desired sound, however, can sometimes be obscured or even rendered inaudible due to background noises. Examples of background noises can include sounds from traffic, alarms, power tools, air conditioning, or other sound sources. By reducing or removing background noises, a desired sound can be more readily detected, especially by people who are hearing impaired.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various techniques have been developed to reduce or remove background noises from a sound signal. For example, certain hearing aids can detect and remove background noises at certain frequencies via spectral extraction, non-linear processing, finite impulse response filtering, or other suitable techniques. By applying such techniques, background noises can be suppressed or attenuated to emphasize human speech. In another example, a noise canceling headphone can detect ambient noises (e.g., sounds from refrigerators, fans, etc.) from outside the headphone using one or more microphones. The detected ambient noises can then be removed or suppressed by applying corresponding sound waves with opposite amplitudes. As such, music, conversations, or other suitable sound played through the headphone can be heard without interference from the ambient noises.

The foregoing techniques for attenuating background noises, however, have certain drawbacks. For instance, removing background noises from a detected sound single may also remove important information contained in the background noises. In one example, background noises from a detected sound signal may contain sounds of an alarm, a door knock, an emergency siren, an approaching vehicle, etc. In another example, a person wearing a noise canceling headphone may not notice someone is calling his/her name or is shouting out a warning about on-coming traffic or other dangers. As such, removing background noises can render a person less aware of his/her environment, and thus negatively impact his/her safety, interactions with other people, or other aspects of the person's daily life.

Several embodiments of the disclosed technology can address at lease certain aspects of the foregoing drawbacks by implementing intelligent information capturing in a sound device. In one embodiment, a sound device can be a hearing aid suitable for improving hearing ability of a person with hearing impairment. In other embodiments, the sound device can also include a noise canceling headphone, a noise isolating headphone, or other suitable types of listening device. In some embodiments, the sound device can include one or more microphones, one or more speakers, a processor, and a memory containing data representing a set of sound models. The processor of the sound device can be configured to execute instructions to perform intelligent information capturing based on the sound models, as described in more detail below.

In certain embodiments, the microphones of the sound device can be configured to capture a sound signal from an environment in which the sound device is located. The captured sound signal is referred to herein as an original sound and can have a frequency range, such as from about 100 Hz to about 8000 Hz, from about 600 Hz to about 1600 Hz, or other suitable values. In certain implementations, the original sound can be divided into a number of frequency bands, for instance, ten to fifteen frequency bands from about 100 Hz to about 8000 Hz. The original sound can then be digitized, for instance, by converting an analog signal from the microphones at each frequency band (or in other suitable manners) into a digital signal (referred to herein as a “digitized signal”) using an analog-to-digital converter (ADC). The digitized signal can then be compared with one or more sound models stored at the memory of the sound device or otherwise accessible by the sound device via, for instance, a computer network such as the Internet.

The sound models can individually include an identification of a sound, one or more corresponding sound signature(s) of the sound, and one or more corresponding actions. For instance, one example sound model can identify a known sound of an approaching vehicle. Another example sound model can identify a sound of an emergency siren or an alarm. A further example sound model can identify human speech. Example sound signatures can include values, value ranges, or patterns of frequency, frequency distribution, sound amplitude at frequency bands, frequency/amplitude variations (e.g., repetitions, attenuations, etc.), and/or other suitable parameters of the corresponding sound.

The sound signatures can be developed according to various suitable techniques. In certain implementations, a model developer can be configured to develop the sound signatures from a training dataset. For instance, a sample sound (e.g., a sound from an approaching vehicle) can be captured using one or more microphones and then digitized using an ADC into a training dataset. According to one example technique, the model developer can then treat frequency spectra of the training dataset as vectors in a high-dimensional frequency feature domain. In such a domain, a vector distribution, e.g., a mean frequency vector of the training dataset can be calculated and then subtracted from each vector in the training dataset. To capture variation of the frequency vectors within the training dataset, eigenvectors of the covariance matrix of a zero-mean-adjusted training dataset can be calculated. The eigenvectors can represent principal components of the vector distribution. For each eigenvector, a corresponding eigenvalue indicates an importance level of the eigenvector in capturing the vector distribution. Thus, for each training dataset, a mean vector and corresponding most important eigenvectors together can represent a sound signature of the sound of the approaching vehicle.

During operation, when a new sound (not in the training dataset) is detected, the processor of the sound device can be configured to compare a spectrum vector of the captured new sound against the mean vector of the sound model. A difference vector can then be projected into principal component directions to find a residual vector. The coefficients of the residual vector can then be used to identify whether the new sound is a sound from a vehicle as represented in the training dataset. For example, a magnitude of the residual vector can measure the extent to which the captured new sound deviates from that in the sound model. In certain embodiments, if the magnitude of the residual vector is below a preset threshold, the sound device can indicate that the captured new sound matches that in the training dataset. In other embodiments, the captured new sound can be deemed matching the sound in the training dataset based on other suitable criteria.

In other implementations, the model developer can be configured to identify sound signatures based on training datasets using a “neural network” or “artificial neural network” configured to “learn” or progressively improve performance of tasks by studying known examples. In certain implementations, a neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. Typically, artificial neurons are organized in layers. Different layers may perform different kinds of transformations on respective inputs. Signals typically travel from an input layer, to an output layer, possibly after traversing one or more intermediate layers. Thus, by using a neural network, the model developer can provide a set of sound models that can be used by the sound device to recognize certain sounds (e.g., approaching vehicles, human speech, etc.) in the captured sound signal. In additional implementations, the model developer can be configured to perform sound signature identification based on user provided rules or via other suitable techniques.

In any of the foregoing implementations, upon identifying the digitized signal of the captured sound signal matches at least one sound model, the sound device can be configured to perform one or more corresponding actions included in the sound model. For instance, the sound device can be configured to determine whether the captured sound signal represents and/or includes human speech. In certain embodiments, upon determining that the detect sound includes human speech, the sound device can be configured to playback the human speech directly to a user of the sound device via the one or more speakers. In other embodiments, upon determining that the captured sound signal includes human speech, the sound device can be configured to extract the human speech (e.g., via spectral extraction and/or signal to noise enhancement) and perform speech to text conversion to derive a speech text via, for instance, feature extraction or other suitable techniques.

Based on the derived speech text, the sound device can be configured to perform various additional actions indicated in the corresponding sound model. For example, the sound device can be configured to determine whether the speech text represents a command from the user of the sound device. For instance, the speech text can include a command such as “up volume” or “lower volume.” In response, the sound device can be configured to incrementally or in other suitably manners increase a volume setting on the speakers of the sound device. In another example, the sound device may be operatively coupled to a computing device (e.g., a smartphone), and the speech text can include a command for interacting with the computing device, such as “call home.” In further examples, the sound device and/or the computing device can be communicatively coupled to a digital assistant, such as Alexa provided by Amazon.com of Seattle, Washington. The command can include a command that interacts with the digital assistant. For instance, the command can cause the digital assistant to perform certain operations, such as creating a calendar item, send an email, turning on a light, etc.

In yet further examples, the sound device can be configured to determine whether the speech text includes one or more keywords preidentified by the user and perform a corresponding preset operation accordingly. For example, a keyword can be selected by the user to include the user's name (e.g., “Bob”). Upon determining that the speech text represents someone calling “Bob,” in one embodiment, the sound device can be configured to playback a preconfigured message to the user via the speakers of the sound device, such as “someone just called your name.” In another instance, the sound device can also provide a text, sound, or other suitable forms of notification on a connected device, such as a smartphone, in addition to or in lieu of performing playback of the preconfigured message.

In response to determining that the captured sound signal does not include human speech, the sound device can be configured to identify one or more known sounds (e.g., a sound of an approaching vehicle) from the digitized signal based on the sound models. Upon identifying one or more known sounds, the sound device can be configured to select for playback a preconfigured message corresponding to the detected known sounds. For example, upon determining that the identified sound is that of an approaching vehicle, the sound device can be configured to select a preconfigured message such as “warning, vehicle approaching.” In one embodiment, the sound device can then be configured to perform text to speech conversion of the selected preconfigured message and then playback the message to the user via the speakers of the sound device. In other embodiments, the sound device can also be configured to provide a text, a sound, a flashing light, or other suitable forms of notification on a connected device (e.g., a smartphone) in addition to or in lieu of playback the selected message.

Several embodiments of the disclosed technology can thus improve the user's awareness of his/her environment by capturing useful information that is normally discarded when suppressing background noises. For example, by identifying a sound of a vehicle approaching, an emergency siren, or other alarms from background noises, the sound device can promptly provide notifications to the user via the speakers of the sound device and/or a connected smartphone. As such, safety of the person can be improved. In another example, by identifying a captured sound signal includes a door knock or someone calling the user's name, interaction and attentiveness of the user can also be improved.

In the foregoing description, various operations of intelligent information capturing are described as being performed by the processor of the sound device. In other implementations, at least some of the foregoing operations of intelligent information capturing can be performed by a computing device (e.g., a smartphone) operatively coupled to the sound device via, for instance, a Bluetooth, WIFI, or other suitable connection. As such, the set of sound models can be stored in the computing device instead of the sound device. In further implementations, the sound device and/or the computing device can be communicatively connected to a remote server (e.g., a server in a cloud computing data center), and at least some of the operations of intelligent information capturing, such as identifying sound(s) based on sound models, can be performed by a virtual machine, a container, or other suitable components of the remote server.

### BRIEF DESCRIPTION OF THE DRAWINGS

FIGS. 1A-1E are schematic diagrams illustrating a sound device implementing intelligent information capturing during certain stages of operation in accordance with embodiments of the disclosed technology.

FIGS. 2A and 2B are schematic diagrams illustrating a sound device operatively coupled to a mobile device implementing intelligent information capturing during certain stages of operation in accordance with embodiments of the disclosed technology.

FIG. 3A and 3B are schematic diagrams illustrating a sound device operatively coupled to a remote server implementing intelligent information capturing during certain stages of operation in accordance with embodiments of the disclosed technology.

FIG. 4 is a schematic diagram illustrating a model developer configured to develop sound models in accordance with embodiments of the disclosed technology.

FIG. 5 is a schematic diagram illustrating an example schema for a sound model in accordance with embodiments of the disclosed technology.

FIGS. 6A and 6B are flowcharts illustrating processes of intelligent information capturing in sound devices in accordance with embodiments of the disclosed technology.

FIG. 7 is a computing device suitable for certain components of the computing system in FIGS. 1A-3B.

### DETAILED DESCRIPTION

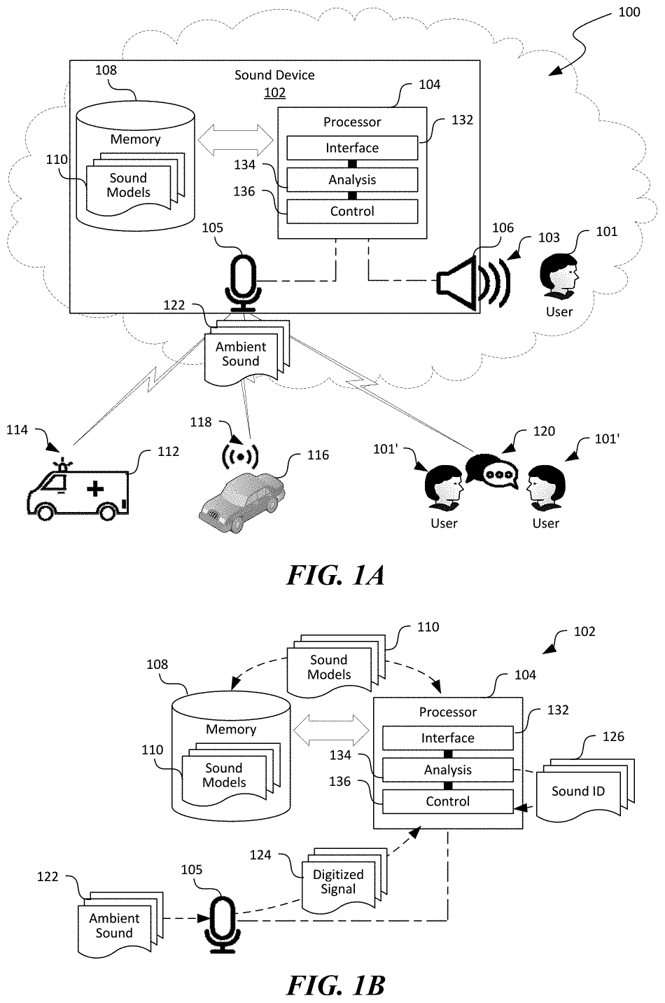

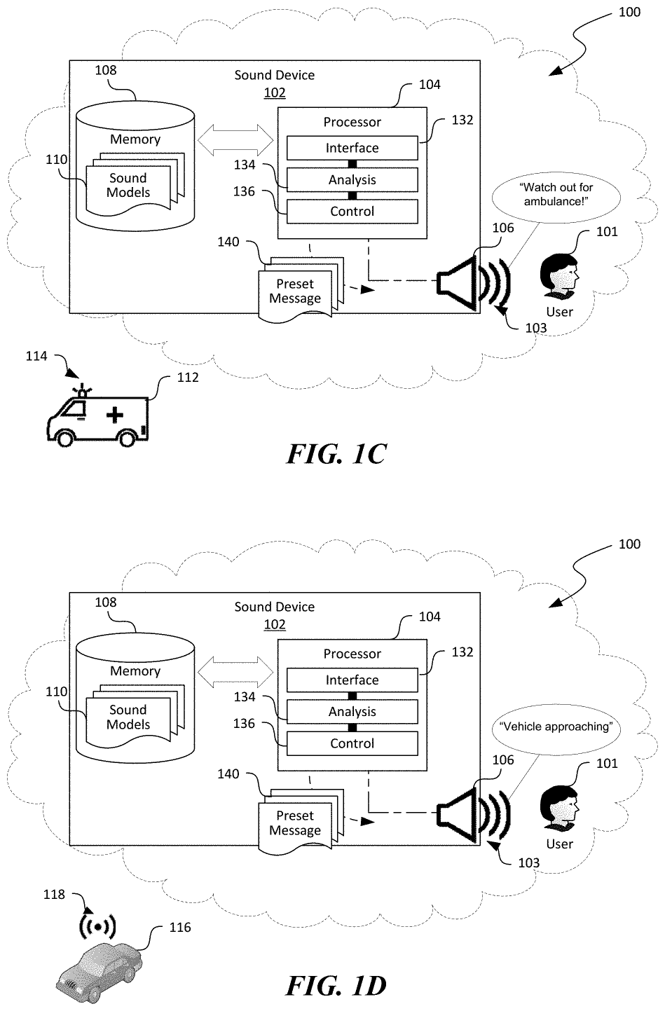

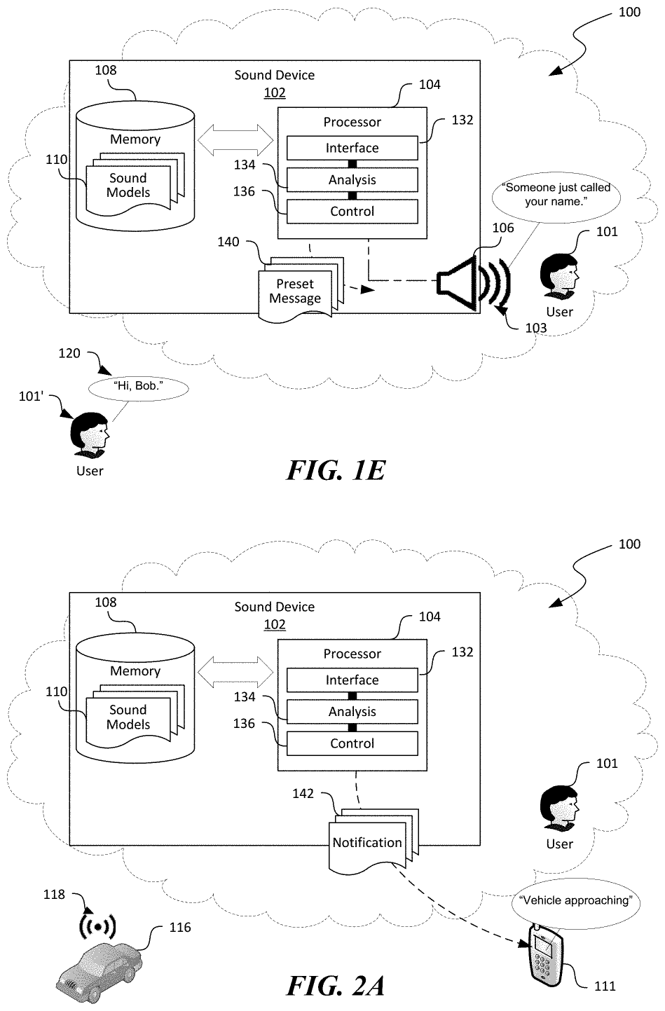

Certain embodiments of systems, devices, components, modules, routines, data structures, and processes for intelligent information capturing in sound devices are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1A-7.

As used herein, “sound” generally refers to a vibration that can propagate as a wave of pressure through a transmission medium such as a gas (e.g., air), liquid (e.g., water), or solid (e.g., wood). A sound can be captured using an acoustic/electric device such as a microphone to convert the sound into an electrical signal. In certain implementations, the electronical signal can be an analog sound signal. In other implementations, the electrical signal can be a digital sound signal by, for example, sampling the analog sound signal using an ADC. A sound can be produced using an electroacoustic transducer, such as a speaker that converts an electrical signal into a corresponding sound.

Also used herein, an “ambient sound” generally refers to a composite sound that can be captured by a microphone or heard by a person in an environment in which the microphone or person resides. Ambient sound can include both desired sound, such as a conversation with another person or music played in a speaker or headphone, and unwanted sound referred to herein as “noise,” “background noise,” or “ambient noise.” Examples of noises can include sounds from traffic, alarms, power tools, air conditioning, or other sound sources.

Noises in an ambient sound can sometimes obscure or even render inaudible desired sound, such as a desired conversation or music. Various techniques have been developed to reduce or remove background noises from a sound signal. For example, certain hearing aids can detect and remove background noises at certain frequencies via spectral extraction, non-linear processing, finite impulse response filtering, or other suitable techniques. By applying such techniques, background noises can be suppressed or attenuated to emphasize desired human speech. In another example, a noise canceling headphone can detect ambient noises (e.g., sounds from refrigerators, fans, etc.) from outside the headphone using one or more microphones. The detected ambient noises can then be removed or suppressed by applying corresponding sound waves with opposite amplitudes. As such, desired music, conversations, or other suitable sound played through the headphone can be heard without interference from the ambient noises.

The foregoing techniques for attenuating background noises, however, have certain drawbacks. For instance, removing background noises from an ambient sound may also remove important information contained in the background noises. In one example, the background noises may contain sounds of an alarm, a door knock, an emergency siren, an approaching vehicle, etc. In another example, a person wearing a noise canceling headphone may not notice someone is calling his/her name or is shouting out a warning about on-coming traffic or other dangers. As such, removing background noises can render a person less aware of his/her environment, and thus negatively impact his/her safety, interactions with other people, or other aspects of the person's daily life.

Several embodiments of the disclosed technology can address at lease certain aspects of the foregoing drawbacks by implementing intelligent information capturing in a sound device, such as a hearing aid or headphone. In certain embodiments, an ambient sound can be captured using a microphone. The ambient sound can then be digitized into a digital sound signal. A sound device can then analyze the digital sound signal to determine whether the digital sound signal contains one or more signal profiles that match sound signatures in one or more sound models. In response to determining that the digital sound signal has a sound profile that matches the sound signature of one of the sound models, the sound device can output, via the speaker, an audio message to the user identifying the known sound while suppressing the captured ambient sound from the environment. As such, ambient noises can be suppressed while useful information from the suppressed ambient noises can be maintained, as described in more detail below with reference to FIGS. 1A-7.

FIGS. 1A-1E are schematic diagrams illustrating a sound device 102 implementing intelligent information capturing during certain stages of operation in accordance with embodiments of the disclosed technology. Not all components are shown in every figure herein for clarity. In FIGS. 1A-1E and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices.

Equally, components may include hardware circuitry. A person of ordinary skill in the art would recognize that hardware may be considered fossilized software, and software may be considered liquefied hardware. As just one example, software instructions in a component may be burned to a Programmable Logic Array circuit or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 1A, a user 101 can wear, carry, or otherwise have a sound device 102 in an environment 100 with an ambient sound 122. In the illustrated example, the ambient sound 122 includes a siren sound from an ambulance 112, a vehicle sound 118 of a vehicle 116, or a conversation 120 between additional users 101′. In other examples, the ambient sound 122 can include sounds from power tools, machines, or other suitable sources. In the environment 100, the ambient sound 122 can be at least partially suppressed. For example, the user 101 can be hearing impaired such that the user 101 cannot hear at least a portion of the ambient sound 122, for instance, at certain frequency ranges. In another example, the sound device 102 can be a noise canceling and/or isolating headphone such that the sound device 102 can at least partially suppress the ambient sound 122. In further examples, the user 101 can be at least partially isolated from the ambient sound 122 due to sound barriers or in other suitable manners.

In one embodiment, the sound device 102 can be a hearing aid suitable for improving hearing of the user 101 with hearing impairment. In other embodiments, the sound device 102 can also include a noise canceling headphone, a noise isolating headphone, or other suitable types of listening device. As shown in FIG. 1A, the sound device 102 can include a processor 104, a memory 108, a microphone 105, and a speaker 106 operatively coupled to one another. Though particular components of the sound device 102 is shown in FIG. 1A, in other embodiments, the sound device 102 can also include additional and/or different hardware/software components. For example, the sound device 102 can also include additional microphones, speakers, ADCs, digital to analog converters (DACs), and/or other suitable parts.

The microphone 105 can be configured to capture the ambient sound 122. The speaker 106 can be configured to produce an output sound 103 to the user 101. In certain embodiments, the microphone 105 can be configured to capture the ambient sound 122 from the environment 100. The captured ambient sound 122 can have a frequency range, such as from about 100 Hz to about 8000 Hz, from about 600 Hz to about 1600 Hz, or other suitable values. In certain implementations, the captured ambient sound 122 can be divided into a number of frequency bands, for instance, ten to fifteen frequency bands from about 100 Hz to about 8000 Hz. The captured ambient sound 122 can then be digitized, for instance, by converting an analog signal from the microphone 105 at each frequency band (or in other suitable manners) into a digital signal (shown in FIG. 1A as a “digitized signal 124”) using an analog-to-digital converter (ADC). The digitized signal 124 can then be compared with one or more sound models 110 stored at the memory 108 of the sound device 102, as described below.

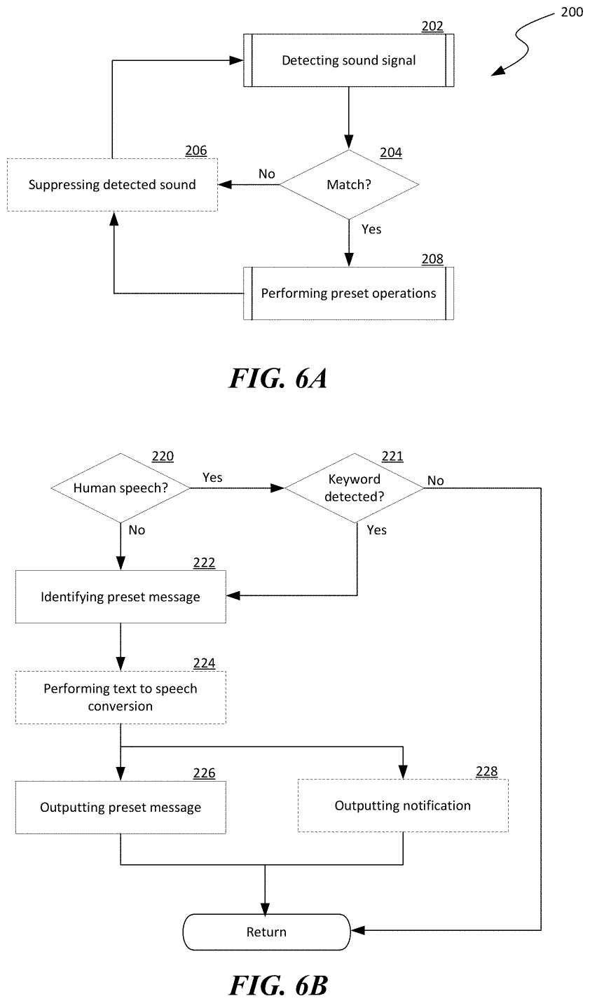

The processor 104 can include a microprocessor, a field-programmable gate array, and/or other suitable logic devices. The memory 108 can include volatile and/or nonvolatile media (e.g., ROM; RAM, magnetic disk storage media; optical storage media; flash memory devices, and/or other suitable storage media) and/or other types of computer-readable storage media configured to store data, such as records of sound models 110, as well as instructions for, the processor 104 (e.g., instructions for performing the methods discussed below with reference to FIGS. 6A and 6B). The sound models 110 can individually include an identification of a known sound, one or more corresponding sound signature(s) of the sound, and one or more corresponding actions. For instance, one example sound model can identify a sound of an approaching vehicle. Another example sound model can identify a sound of an emergency siren or an alarm. A further example sound model can identify human speech. Example sound signatures can include values, value ranges, or patterns of frequency, frequency distribution, sound amplitude at frequency bands, frequency/amplitude variations (e.g., repetitions, attenuations, etc.), and/or other suitable parameters of the corresponding sound. One example data schema suitable for a sound model 110 is described in more detail below with reference to FIG. 5.

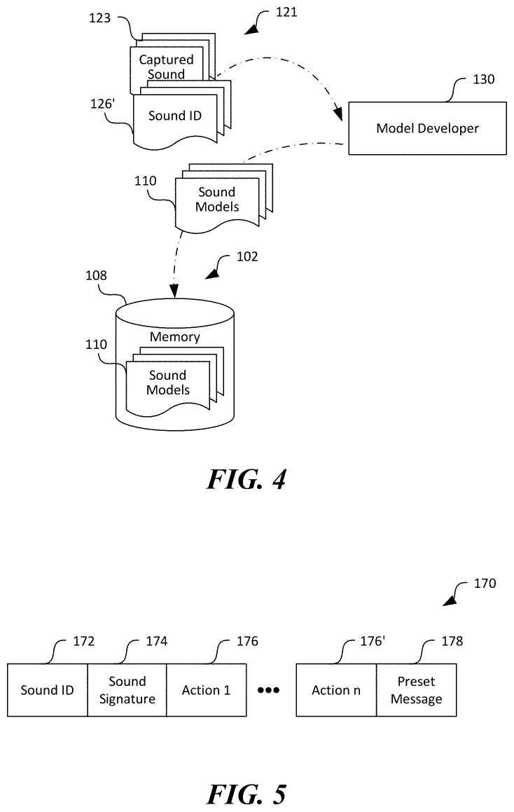

The sound signatures can be developed according to various suitable techniques. In certain implementations, a model developer 130 (shown in FIG. 4) can be configured to develop the sound signatures from a training dataset. For instance, a sample sound (e.g., a sound from an approaching vehicle) can be captured using one or more microphones and then digitized using an ADC into a training dataset. According to one example technique, the model developer 130 can then treat frequency spectra of the training dataset as vectors in a high-dimensional frequency feature domain. In such a domain, a vector distribution, e.g., a mean frequency vector of the training dataset can be calculated and then subtracted from each vector in the training dataset. To capture variation of the frequency vectors within the training dataset, eigenvectors of the covariance matrix of a zero-mean-adjusted training dataset can be calculated. The eigenvectors can represent principal components of the vector distribution. For each eigenvector, a corresponding eigenvalue indicates an importance level of the eigenvector in capturing the vector distribution. Thus, for each training dataset, a mean vector and corresponding most important eigenvectors together can represent a sound signature of the sound of the approaching vehicle. In other implementations, the model developer 130 can be configured to identify sound signatures based on training datasets using a “neural network” or “artificial neural network” configured to “learn” or progressively improve performance of tasks by studying known examples, as described in more detail below with reference to FIG. 4. In additional implementations, the model developer can be configured to perform sound signature identification based on user provided rules or via other suitable techniques.

The processor 104 can be configured to execute suitable instructions to provide certain components for facilitating intelligent information capturing in the sound device 102. For example, as shown in FIG. 1A, the processor 104 can include an interface component 132, an analysis component 134, and a control component 136 operatively coupled to one another. Though particular components are shown in FIG. 1A for illustration purposes, in other embodiments, the processor 104 can also include a sound suppression component, a network interface component, and/or other suitable types of component.

The interface component 132 can be configured to receive input from the microphone 105 as well as provide an output to the speaker 106. In one embodiment, as shown in FIG. 1B, the interface component 132 can be configured to receive the digitized signal 124 of the captured ambient sound 122 from the microphone 105. In other embodiments, the interface component 132 can also be configured to receive an analog signal (e.g., a 1 to 5 volt signal direct current signal, not shown) of the captured ambient sound 122 from the microphone 105 and digitize the analog signal before providing the digitized signal 124 to the analysis component 134 for further processing.

As shown in FIG. 1B, the analysis component 134 can be configured to determine whether the digitized signal 124 includes a signal profile that matches the sound signature of one of the sound models 110 stored in the memory 108. In one embodiment, the signal profile can include one or more of a range of frequency, a pattern of frequency, a range of frequency distribution, or a pattern of frequency distribution of the captured ambient sound 122. In other embodiments, the signal profile can include other suitable parameters of the captured ambient sound 122. For example, the analysis component 134 can be configured to compare a spectrum vector of the digitized signal 124 against the mean vector of one of the sound models 110. A difference vector can then be projected into principal component directions to find a residual vector. The coefficients of the residual vector can then be used to identify whether the captured ambient sound is a known sound (e.g., a sound from a vehicle) indicated in the sound model 110. For example, a magnitude of the residual vector can measure the extent to which the captured ambient sound 122 deviates from that in the sound model 110. In certain embodiments, if the magnitude of the residual vector is below a preset threshold, the analysis component 134 can indicate that the captured ambient sound 122 matches that in the sound model 110. In other embodiments, the captured ambient sound 122 can be deemed matching the sound in the sound model 110 based on other suitable criteria.

Upon identifying the digitized signal 124 of the captured ambient sound 122 matches at least one sound model 110, the analysis component 134 can be configured to indicate such matching and provide, for example, a sound identification (shown in FIG. 1B as “sound ID 126” to the control component 136 for further processing. In turn, the control component 136 can be configured to perform one or more corresponding actions included in the sound model 110. For instance, the sound device can be configured to determine whether the captured ambient sound 122 represents and/or includes human speech.

In response to determining that the captured ambient sound 122 does not include human speech, the control component 136 can be configured to identify one or more known sounds and select for playback a preconfigured message corresponding to the detected known sounds. For example, as shown in FIG. 1C, upon determining that the identified sound is a siren 114 from an ambulance 112, the control component 136 can be configured to instruct the speaker 106 to select a preset message 140, such as “Watch out for ambulance.” In another example, as shown in FIG. 1D, upon determining that the identified sound is a vehicle sound 118 of an approaching vehicle 116, the control component 136 can be configured to instruct the speaker 106 to select a preset message 140, such as “Vehicle approaching.”

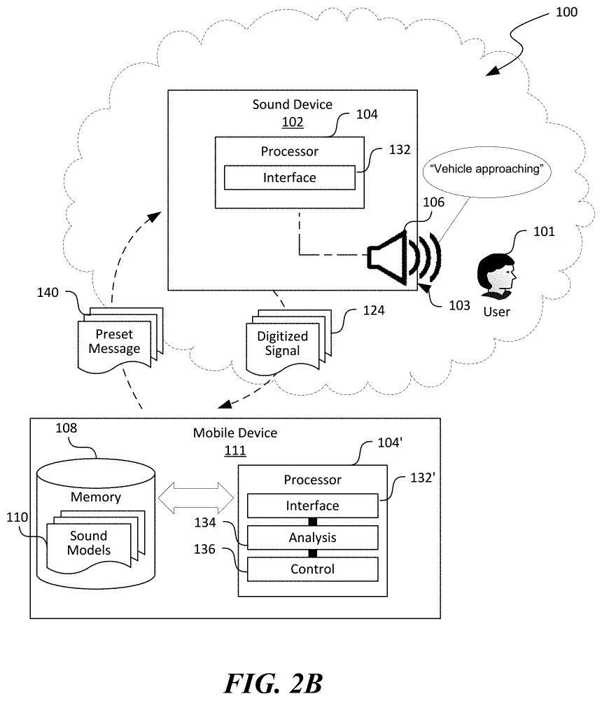

In one embodiment, the control component 136 can then be configured to perform text to speech conversion of the selected preset message 140 and then playback the converted message to the user 101 via the speaker 106. In another embodiment, the control component 136 can be configured to select a sound file (not shown) corresponding to the preset message 140 and then instruct the speaker 106 to playback the sound file. In other embodiments, the control component 136 can also be configured to provide a text, a sound, a flashing light, or other suitable forms of notification 142 (shown in FIG. 2A) on a connected device 111 (e.g., a smartphone shown in FIG. 2A) in addition to or in lieu of playback the selected message 140.

In response to determining that the ambient sound 122 includes human speech, in one embodiment, the control component 136 can be configured to playback the human speech directly to the user of the sound device 102 via the speaker 106. In other embodiments, as shown in FIG. 1E, upon determining that the captured ambient sound 122 includes human speech, the control component 136 can be configured to extract the human speech (e.g., via spectral extraction and/or signal to noise enhancement) and perform speech to text conversion to derive a text string via, for instance, feature extraction or other suitable techniques.

In one implementation, the control component 136 can be configured to determine whether the text string represents a command to the sound device 102, such as “volume up” or “volume down.” In response to determining that the text string represents a command to the sound device 102, the control component 136 can be configured to execute the command to, for instance, adjust a volume of the speaker 106. In another implementation, the control component 136 can be configured to determine whether the text string represents a command to a digital assistant (e.g., Alexa provided by Amazon.com of Seattle, Washington). In response to determining that the text string represents a command to a digital assistant, the control component 136 can be configured to transmit the command to the digital assistant via a computer network (not shown) and/or provide output to the user 101 upon receiving feedback from the digital assistant. In further implementations, the control component 136 can also be configured to determine whether the text string includes one or more keywords pre-identified by the user 101. Examples of the keywords can include a name (e.g., “Bob”) of the user 101. In response to determining that the text string includes one or more keywords pre-identified by the user 101, the control component 136 can be configured to output an audio message to the user 101 informing the user 101 that the one or more keywords have been detected. For instance, as shown in FIG. 1E, the control component 136 can be configured to instruct the speaker 106 to output an audio message of “Someone just called your name.”

In further embodiments, the control component 136 can also be configured to perform sound suppression, compensation, or other suitable operations. For example, the control component 136 can be configured to modify, an amplitude of one or more of frequency ranges of the captured ambient sound 122 and outputting the captured ambient sound 122, via the speaker 106, with the modified amplitude at one or more of the frequency ranges along with the preset message 140. In another example, the control component 136 can also be configured to generate another digital or analog sound signal (not shown) having the multiple frequency ranges with corresponding amplitude opposite that of the captured ambient sound 122 and output, via the speaker 106, the generated sound signal along with the preset message 140 to at least partially cancel or attenuate the ambient sound 122.

Even though output provided to the user 101 is shown as being through the speaker 106 in FIGS. 1A-1E, in other embodiments, the control component 136 can also be configured to provide notifications in other suitable manners. For example, as shown in FIG. 2, the control component 136 can also be configured to provide a notification 142 to a mobile device 111 (shown as a smartphone) of the user 101 to be displayed on the mobile device 111. The mobile device 111 can be connected to the sound device 102 via a WIFI, Bluetooth, or other suitable types of connection.

In further embodiments, at least some of the operations of intelligent information capturing can be performed on the mobile device 111. For instance, as shown in FIG. 2B, the interface component 132 of the sound device 102 can be configured to transmit the digitalized signal 124 to the mobile device 111 via a corresponding interface component 132′. The analysis component 134 and the control component 136 on the mobile device 111 can then perform the foregoing operations discussed above with reference to FIGS. 1A-1E. The mobile device 111 can the provide the preset message 140 to the sound device 102 for playback to the user 101.

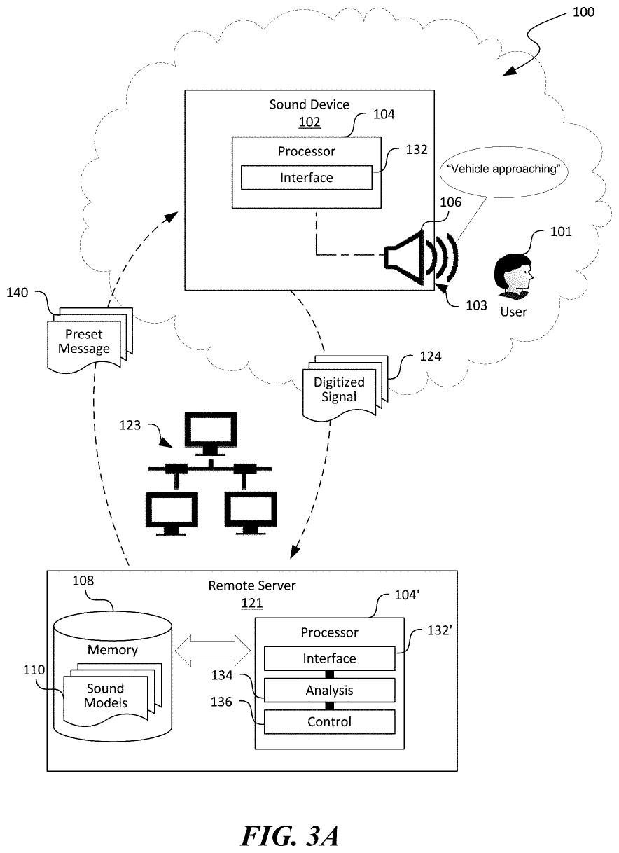

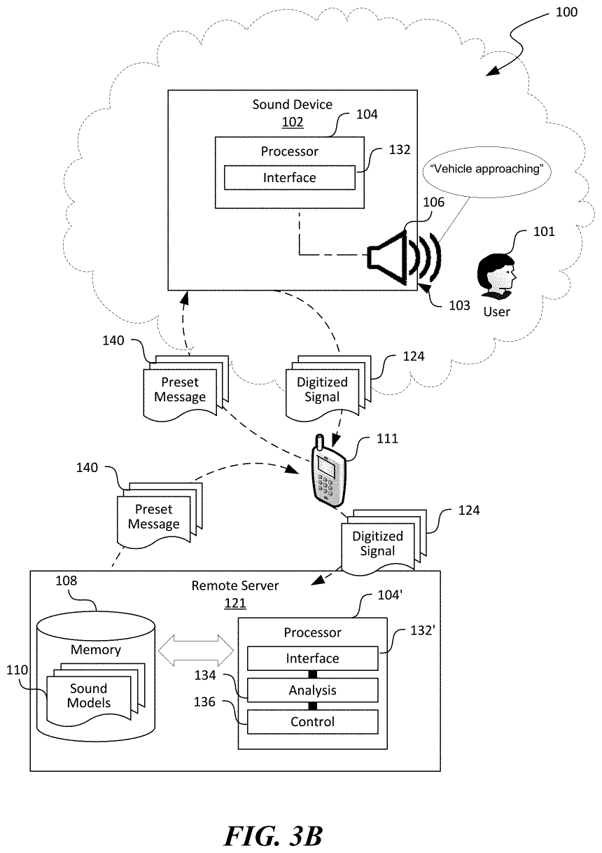

In yet further embodiments, at least some of the operations of intelligent information capturing can be performed on a remote server 121, as shown in FIG. 3A. In the illustrated embodiment, the sound device 102 is communicatively coupled to the remote server 121 (e.g., a server in a cloud computing data center) via a computer network 123 (e.g., the Internet). The interface component 132 of the sound device 102 can be configured to transmit the digitized signal 124 to the remote server 121 via the computer network 123 for processing, as described above with reference to FIGS. 1A-1E. Subsequently, the remote server 121 can be configured to provide the preset message 140 to the sound device 102 via the computer network 123. In yet other embodiments, the digitized signal 124 and/or the preset message 140 can be transmitted between the sound device 102 and the remote server 121 via the mobile device 111, as shown in FIG. 3B.

FIG. 4 is a schematic diagram illustrating a model developer 130 configured to develop sound models 110 in accordance with embodiments of the disclosed technology. As shown in FIG. 4, the model developer 130 can be configured to identify sound signatures based on training datasets 121 having captured sound 123 and corresponding sound identifications (shown in FIG. 4 as “sound ID 126′) using a “neural network” or “artificial neural network” configured to “learn” or progressively improve performance of tasks by studying known examples. In certain implementations, a neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. Typically, artificial neurons are organized in layers. Different layers may perform different kinds of transformations on respective inputs. Signals typically travel from an input layer, to an output layer, possibly after traversing one or more intermediate layers. Thus, by using a neural network, the model developer 130 can provide a set of sound models 110 that can be used by the sound device to recognize certain sounds (e.g., approaching vehicles, human speech, etc.) in the captured sound 123.

FIG. 5 is a schematic diagram illustrating an example schema 170 for a sound model in accordance with embodiments of the disclosed technology. As shown in FIG. 5, the example schema 170 can include a sound ID field 172, a sound signature field 174, one or more action fields 176 (shown as “Action 1 176” and “Action n 176′), and a preset message field 178. The sound ID field 172 can be configured to store data representing an identification of known sound. Example identification can include a numerical code, a text description, or other suitable data. The sound signature filed 174 can be configured to store a sound signature corresponding to the sound identification. In one example, the sound signature can include a mean vector and corresponding most important eigenvectors of a sound based on spectral analysis. In other examples, the sound signature can also include other suitable parameters of the sound. The action field 176 can be configured to store data representing an operation to be performed upon detecting the sound. In one example, an action can include playback a preset message stored in the preset message field 178. In another example, an action can include performing text to speech conversation of the preset message before playback. In further examples, the action can include amplifying the sound, attenuating the sound, or perform other suitable operations, as described above with reference to FIGS. 1A-1E.

FIGS. 6A and 6B are flowcharts illustrating processes of intelligent information capturing in a sound device 102 in accordance with embodiments of the disclosed technology. Though the processes are described below with reference to the sound device 102 and the environment 100 in FIGS. 1A-3B, in other embodiments, the processes can also be implemented in other suitable environment.

As shown in FIG. 6A, a process 200 can include detecting a sound signal of an ambient sound at stage 202. The sound signal can be detected using, for instance, a microphone 105 in FIG. 1A. The process 200 can then include a decision stage 204 to determine whether a signal profile of the sound signal matches a sound signature of a sound model 110 (FIG. 1A), as described above with reference to FIGS. 1A-1E. In response to determining that a match is found, the process 200 can include performing certain preset operations at stage 208. One example preset operation can include outputting, via the speaker 106 (FIG. 1A), an audio message to a user identifying the known sound corresponding to the sound model. Additional examples of performing preset operations are described in more detail below with reference to FIG. 6B. The process 200 can then proceed to an optional stage of suppressing the detected sound at stage 206. In response to determining that a match is not found, the process 200 can proceed directly to the optional stage 206.

As shown in FIG. 6B, example operations of performing preset operations can include a decision stage 220 to determine whether human speech is detected. In response to determining that human speech is detected, the operations proceed to another decision stage 221 to determine whether any predefined keywords are detected in the human speech. In response to determining that no predefined keywords are detected, or no human speech is detected, the operations return to, for instance, the optional stage 206 of FIG. 6A. Otherwise, the operations proceed to identifying a preset message at a stage 222. The operations can then include an optional stage 224 of performing text to speech conversion of the preset message. The operations can then proceed to outputting the preset message to the user at stage 226 and optionally outputting a notification to, for instance, a mobile device 111 (FIG. 2A) of the user at stage 228.

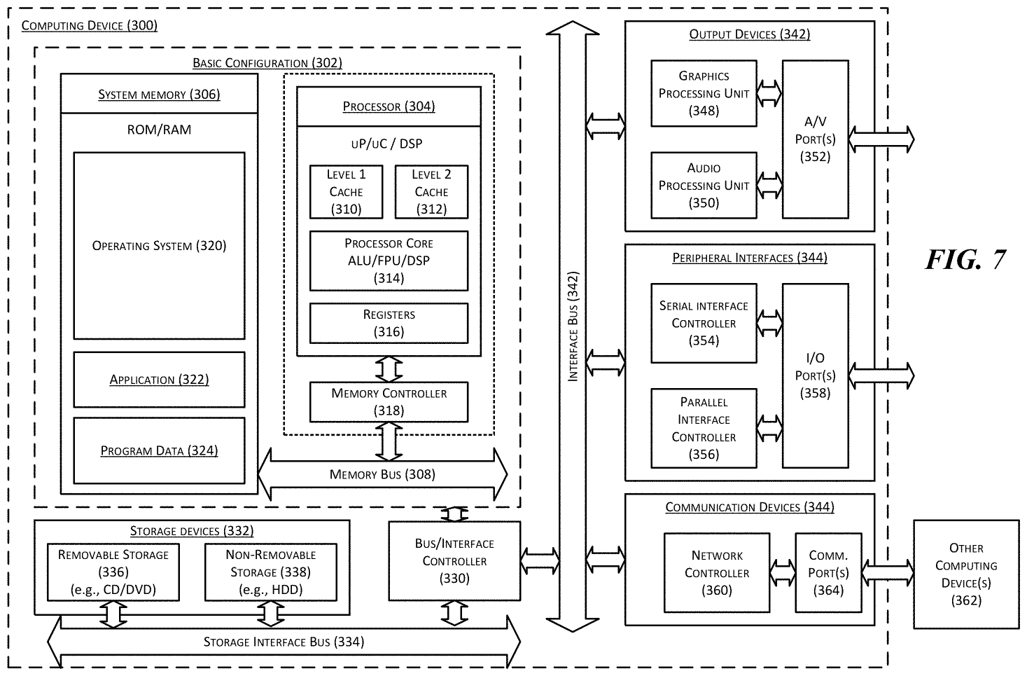

FIG. 7 is a computing device 300 suitable for certain components in FIGS. 1A-3B. For example, the computing device 300 can be suitable for the sound device 102 of FIGS. 1A-3B, the mobile device 111 of FIGS. 2A and 2B, or the remote server 121 of FIGS. 3A and 3B. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more level of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 6 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

1. A method of intelligent information capturing by a sound device having a microphone, a speaker, a memory, and a processor operatively coupled to one another, the memory containing records of sound models each corresponding to a known sound and having a sound signature, wherein the method comprising:
capturing, via the microphone, an ambient sound from an environment in which a user wearing the sound device is in, the captured ambient sound having a background noise of a first frequency range represented by data of a digital sound signal and a target sound of a second frequency range;
suppressing, with the sound device, the background noise in the captured ambient sound of the first frequency range while allowing the target sound at the second frequency range to pass through the sound device; and
while suppressing the background noise at the sound device,
determining, with the processor, whether at least a part of the digital sound signal of the background noise has a signal profile that matches the sound signature of one of the sound models stored in the memory, the signal profile including one or more of a range of frequency, a pattern of frequency, a range of frequency distribution, or a pattern of frequency distribution of the digital sound signal; and
in response to determining that the digital sound signal has a sound profile that matches the sound signature of one of the sound models, outputting, via the speaker of the sound device, an audio message to the user identifying the known sound corresponding to the one of the sound models while suppressing the background noise at the first frequency range in the captured ambient sound from the environment.

2. The method of claim 1 wherein:
the one of the sound models also includes a text message corresponding to the known sound;
the method further includes performing, at the processor, text to speech conversion of the text message to generate the audio message; and
wherein outputting the audio message includes outputting, via the speaker, the generated audio message to the user.

3. The method of claim 1 wherein:
the one of the sound models also includes a sound file corresponding to the known sound; and
outputting the audio message includes playing, via the speaker, the sound file to produce the audio message to the user.

4. The method of claim 1 wherein:
the known sound includes one of an approaching vehicle, an emergency siren, or an alarm; and
outputting the audio message includes outputting, via the speaker, an audio warning regarding the approaching vehicle, the emergency siren, or the alarm while at least partially suppressing a sound made by the approaching vehicle, the emergency siren, or the alarm.

5. The method of claim 1, further comprising:
in response to determining that the digital sound signal has a signal profile that matches the sound signature of one of the sound models,
determining, at the processor, whether the known sound corresponding to the one of the sound models is human speech; and
in response to determining that the known sound is human speech, performing speech to text conversion of the digital sound signal to derive a text string.

6. The method of claim 1, further comprising:
in response to determining that the digital sound signal has a signal profile that matches the sound signature of one of the sound models, determining, at the processor, whether the known sound corresponding to the one of the sound models is human speech; and
in response to determining that the known sound is human speech,
performing speech to text conversion of the digital sound signal to derive a text string;
determining whether the text string represents a command to the sound device; and
in response to determining that the text string represents a command to the sound device, executing the command with the processor.

7. The method of claim 1, further comprising:
in response to determining that the digital sound signal has a signal profile that matches the sound signature of one of the sound models, determining, at the processor, whether the known sound corresponding to the one of the sound models is human speech; and
in response to determining that the known sound is human speech,
performing speech to text conversion of the digital sound signal to derive a text string;
determining whether the text string represents a command to a digital assistant; and
in response to determining that the text string represents a command to a digital assistant, transmitting the command to the digital assistant via a computer network.

8. The method of claim 1, further comprising:
in response to determining that the digital sound signal has a signal profile that matches the sound signature of one of the sound models, determining, at the processor, whether the known sound corresponding to the one of the sound models is human speech;
in response to determining that the known sound is human speech, performing speech to text conversion of the digital sound signal to derive a text string; and
wherein outputting the audio message includes:
determining whether the text string includes one or more keywords pre-identified by the user; and
in response to determining that the text string includes one or more keywords pre-identified by the user, outputting the audio message to the user informing the user that the one or more keywords have been detected.

9. The method of claim 1 wherein:
the captured ambient sound has multiple frequency ranges with corresponding amplitude; and
the method further includes:
modifying, the amplitude of one or more of the multiple frequency ranges at the captured ambient sound; and
outputting the captured ambient sound, via the speaker, with the modified amplitude at one or more of the multiple frequency ranges along with the audio message.

10. A sound device, comprising:
a microphone;
a speaker;
a processor operatively coupled to the microphone and speaker; and
a memory containing data representing a set of sound models each corresponding to a known sound and having a sound signature, wherein the memory also contains instructions executable by the processor to cause the sound device to:
receive a digital sound signal representing a background noise of a first frequency range of an ambient sound captured via the microphone from an environment in which a user wearing the sound device is in, the ambient sound also including a target sound of a second frequency range; and
in response to receiving the digital sound signal, suppress the background noise of the first frequency range in the captured ambient sound while allowing the target sound at the second frequency range to pass through the sound device;
determine whether the digital sound signal representing the background noise includes a signal profile that matches the sound signature of one of the sound models stored in the memory, the signal profile including one or more of a range of frequency, a pattern of frequency, a range of frequency distribution, or a pattern of frequency distribution of the digital sound signal; and
in response to determining that the digital sound signal has a signal profile that matches the sound signature of one of the sound models, output, via the speaker of the sound device, an audio message to the user identifying the known sound corresponding to the one of the sound models while suppressing the background noise of the first frequency range in the captured ambient sound from the environment.

11. The sound device of claim 10 wherein:
the known sound includes one of an approaching vehicle, an emergency siren, or an alarm; and
to output the audio message includes to output, via the speaker, an audio warning regarding the approaching vehicle, the emergency siren, or the alarm while at least partially suppressing a sound made by the approaching vehicle, the emergency siren, or the alarm.

12. The sound device of claim 10 wherein the memory includes additional instructions executable by the processor to cause the sound device to:
in response to determining that the digital sound signal has a signal profile that matches the sound signature of one of the sound models,
determine whether the known sound corresponding to the one of the sound models is human speech; and
in response to determining that the known sound is human speech, perform speech to text conversion of the digital sound signal to derive a text string.

13. The sound device of claim 10 wherein the memory includes additional instructions executable by the processor to cause the sound device to:
in response to determining that the digital sound signal has a signal profile that matches the sound signature of one of the sound models, determine whether the known sound corresponding to the one of the sound models is human speech; and
in response to determining that the known sound is human speech, perform speech to text conversion of the digital sound signal to derive a text string;
determine whether the text string represents a command to the sound device; and
in response to determining that the text string represents a command to the sound device, execute the command with the processor.

14. The sound device of claim 10 wherein the memory includes additional instructions executable by the processor to cause the sound device to:
in response to determining that the digital sound signal has a signal profile that matches the sound signature of one of the sound models, determine whether the known sound corresponding to the one of the sound models is human speech; and
in response to determining that the known sound is human speech, perform speech to text conversion of the digital sound signal to derive a text string;
determine whether the text string represents a command to a digital assistant; and
in response to determining that the text string represents a command to a digital assistant, transmit the command to the digital assistant via a computer network.

15. The sound device of claim 10 wherein the memory includes additional instructions executable by the processor to cause the sound device to:
in response to determining that the digital sound signal has a signal profile that matches the sound signature of one of the sound models, determine whether the known sound corresponding to the one of the sound models is human speech;
in response to determining that the known sound is human speech, perform speech to text conversion of the digital sound signal to derive a text string; and
wherein to output the audio message includes to:
determine whether the text string includes one or more keywords pre-identified by the user; and
in response to determining that the text string includes one or more keywords pre-identified by the user, output the audio message to the user informing the user that the one or more keywords have been detected.

16. The sound device of claim 10 wherein:
the captured ambient sound has multiple frequency ranges with corresponding amplitude; and
the memory includes additional instructions executable by the processor to cause the sound device to:
modify, the amplitude of one or more of the multiple frequency ranges at the captured ambient sound; and
output the captured ambient sound, via the speaker, with the modified amplitude at one or more of the multiple frequency ranges along with the audio message.

17. The sound device of claim 10 wherein:
the captured ambient sound has multiple frequency ranges with corresponding first amplitude; and
the memory includes additional instructions executable by the processor to cause the sound device to:
generate another digital sound signal having the multiple frequency ranges with corresponding second amplitude opposite the first amplitude of the captured ambient sound; and
output, via the speaker, the generated another digital sound signal along with the audio message, thereby at least partially canceling the captured ambient sound.

18. A method of intelligent information capturing by a computing device having a processor and a memory operatively coupled to the processor, the memory containing records of sound models each corresponding to a known sound with a sound signature, wherein the method comprising:
receiving, a digital sound signal representing a background noise of a first frequency range of an ambient sound captured using a microphone from an environment in which a user is in, the ambient sound also including a target sound of a second frequency range;
suppressing the background noise of the first frequency range in the captured ambient sound while allowing the target sound at the second frequency range to pass through the computing device;
determining, with the processor, whether the received digital sound signal representing the background noise has a signal profile that matches the sound signature of one of the sound models stored in the memory, the signal profile including one or more of a range of frequency, a pattern of frequency, a range of frequency distribution, or a pattern of frequency distribution of the digital sound signal; and
in response to determining that the received digital sound signal has a signal profile that matches the sound signature of one of the sound models, transmitting, a command to a speaker, the command instructing the speaker to playback an audio message to the user identifying the known sound corresponding to the one of the sound models while suppressing the background noise of the first frequency range in the ambient sound.

19. The method of claim 18, further comprising:
in response to determining that the digital sound signal has a signal profile that matches the sound signature of one of the sound models, determining, at the processor, whether the known sound corresponding to the one of the sound models is human speech; and
in response to determining that the known sound is human speech,
performing speech to text conversion of the digital sound signal to derive a text string;
determining whether the text string represents a command to the sound device; and
in response to determining that the text string represents a command to the sound device, executing the command with the processor.

20. The method of claim 18, further comprising:
in response to determining that the digital sound signal has a signal profile that matches the sound signature of one of the sound models, determining, at the processor, whether the known sound corresponding to the one of the sound models is human speech;
in response to determining that the known sound is human speech, performing speech to text conversion of the digital sound signal to derive a text string; and
wherein outputting the audio message includes:
determining whether the text string includes one or more keywords pre-identified by the user; and
in response to determining that the text string includes one or more keywords pre-identified by the user, outputting the audio message to the user informing the user that the one or more keywords have been detected.
